(19) United States
(12) Patent Application Publication
(10) Pub. No.: US 2004/0107130 A1
(43) Pub. Date: Jun. 3, 2004

(54) Physiological gastric bypass by appetite suppression

(76) Inventor: Ronald J. Thompson, Ft. Thomas, KY (US)

Correspondence Address: Donald N. Halgren, 35 Central St., Manchester, MA, 01944, US

(21) Appl. No.: 10/629,533

(22) Filed: Jul. 29, 2003

Related U.S. Application Data
(60) Provisional application No. 60/399,294, filed on Jul. 29, 2002.

(51) Int. Cl. G06F 17/60

(52) U.S. Cl. 705/10

(57) ABSTRACT

A method to suppress appetite in a mammalian body comprising the steps of: stimulating the release of Ghrelin from stomach cells; depleting Ghrelin stored in Gastric cells of the stomach; and blocking a portion of any Ghrelin activity in the brain of the mammalian. The method may include blocking a portion of any Ghrelin activity in the bloodstream of the mammalian. The method may include the reducing of Gastric volume of a mammalian stomach by the steps of: reducing serum Ghrelin levels in the Gastric cells of said mammalian stomach. The appetite suppression may occur preprandially.

### BACKGROUND OF THE INVENTION

1. Field of the Invention

This invention relates to a method to decrease long term appetite, and more particularly to a procedure using serum ghrelin measurements to document and regulate appetite suppression, and is based upon and is a continuation application of Provisional Patent Application Serial No. 60/399,294, filed Jul. 29, 2002, which is incorporated herein by reference.

2. Prior Art

Ghrelin is a neuropeptide hormone that is produced in the stomach and regulates short and long term appetite, hunger, food intake, and satiety.

Ghrelin, initially discovered in 1999 as an analog of growth hormone releasing factor, secretogogne to cause the release of growth hormone, ghrelin (to grow) was discovered by Kojima, as reported in Nature 1999; 402: 656-60, “Ghrelin is a growth-hormone-releasing acylated peptide from stomach.” In Nature 2000; 407: 908-13, Tsclop reported, “ghrelin induces adiposity in rodents.” Wren, in a report in the Journal of Clinical Endocrinology and Metabolism 2001: 86: 5992 reported, “ghrelin enhances appetite and increases food intake in humans.”

Ghrelin is produced in the cells of the stomach lining as documented by electron microscopy immunostaining described by Yukari Date in Endocrinology 2000, pg. 4255, “ghrelin, a novel growth-hormone-releasing acylated peptide, is synthesized in a distinct endocrine cell type in the gastrointestinal tracts of rats and humans.” Ghrelin is released into the blood stream stimulated by multiple factors including gastric acid, glucose, and gastric distention.

Ghrelin has a target effect in the hypothalamus to stimulate appetite, food intake, and ultimately body weight. The actual transport of ghrelin in the blood is yet undescribed. Ghrelin could be transported bound to a serum globulin or in a free unbound state. The specific mechanism at the cellular, molecular level in the hypothalamus to increase appetite and food intake are also undescribed and not yet understood.

Certain general facts are known about all hormones. Hormones are proteins, and are produced by a specific cell for a specific function. They are transported in the blood and made available to every cell of the body, but are only recognized by target tissues, cells that have a receptor for that specific hormone. Hormones are stored within the cell that they are produced in, and a stimulation is necessary to cause that cell to release its' hormone into the blood. Once the cell releases all of its' stored hormone, it becomes refractory, meaning there is no more available hormone to be released even if stimulated again! That cell is refractory until it can again produce and store an adequate inventory of hormone. In the pituitary gland the refractory cycle for FSH (Follicle Stimulating Hormone) is about 90 (ninety) minutes. If the pituitary cells are constantly stimulated without rest, they cease to produce FSH. This mechanism is termed “down regulation.”

Preprandial is mealtime hunger. A recently published article by Cummings et al, “Plasma Ghrelin Levels After Diet Induced Weight Loss or Gastric Bypass Surgery,” New England Journal of Medicine Vol. 346, No. 21, May 23, 2002, pg. 1623 reports that plasma ghrelin levels rise before each meal and fall after each meal. This represents a three or four hour daytime cycle of ghrelin production and release that stimulates appetite. All of us relate preprandial hunger with stomach parastolysis or growling, and the quieting of one's stomach after eating. Probably gastric acid and other factors stimulate the production and release of ghrelin preprandially. Such a relationship is depicted graphically as shown in a graph: Plasma Ghrelin Level (pg/ml) vs. Time in New England Journal of Medicine, Vol. 346, No. 21, May 23, 2002 Pg. 1626.

Dr. Cummings in the “Discussion” section of his article reports:

“Our data are consistent with the hypothesis that ghrelin has a role in both mealtime hunger and the long-term regulation of body weight.”

Long-Term Regulation of Appetite depicted graphically in the above-identified reference entitled: “Ghrelin and Regulation of Body Weight”

That chart “Ghrelin and Regulation of Body Weight” displays two factors about the ghrelin-appetite-body weight system, but only relates ghrelin and body weight.

1) After weight reduction of 20% of body mass the long-term baseline ghrelin levels are increased. This increased baseline hunger and appetite helps explain the regain of lost weight. Elevated ghrelin baseline represents a long-term inherent appetite stimulant.

2) After gastric bypass surgery the baseline ghrelin stabilize at about only 30% of the normal control patients. This is confirmed by the subjective reports that post-operative gastric bypass patients “have a greatly diminished long-term appetite.” The one unanswered question is, “how long post-operative did these ghrelin levels drop? Was this 6 months, 12 months, or 18 months post gastric bypass surgery?”

In gastric bypass surgery, the majority of the stomach is isolated to prevent any food intake and therefore this prevents any distention from food. The stimuli reported to release ghrelin are: gastric acid, glucose, and physical distention. With the stomach only functionally 10% of volume post gastric bypass, the ghrelin producing gastric cells probably atrophy from the lack of distending stimulation. A secondary mechanism that prevents the production of ghrelin from non-functional gastric cells could be the lack of stimulation from glucose and gastric acid. This is a common principle in medicine and especially endocrinology, “use it or lose it.” The lack of stimulation over time causes the hormone producing tissue to atrophy and become nonfunctional. Patients on long-term thyroid hormone develop atrophy of both the cells that produce thyroid-stimulating hormone (TSH) in the pituitary, as well as the TSH's target organ, the thyroid producing cells in the thyroid gland. Patients on long-term cortisol therapy, such as organ transplant patients, develop atrophy of the pituitary cells that produce ACTH, adrenocorticotropic hormone. With no ACTH to stimulate the adrenal cells to produce cortisol, the cortisol producing cells atrophy. If the parenteral source of cortisol is withheld, the patient is unable to produce any cortisol from the atrophied adrenal cells and will develop an addisonian crisis, with shock and death. These are examples of hormone producing cell atrophy from disuse and the lack of stimulation. Most probably the ghrelin cells in the gastric lining of gastric bypass patients atrophy over one to six months of non-stimulating physiological use.

### BRIEF DESCRIPTION OF THE DRAWINGS

The objects and advantages of the present invention will become more apparent when viewed in conjunction with the following drawings in which:

FIG. 1 represents a cross-sectional view of an empty mammalian stomach;

FIG. 2 is a sectional view of Gastric cells with Grehlin therein;

FIG. 3 is a cross sectional view of a stomach pulled;

FIG. 4 is a view similar to FIG. 2 showing Grehlin being released from Gastric cells into the bloodstream;

FIG. 5 represents a cross-sectional view of a Grehlin binding compound entering a stomach;

FIG. 6 is a view similar to FIG. 4 showing the Grehlin binding compound being absorbed by mucosa and in blood;

FIG. 7 represents a cross-sectional view of a high fiber “cookie” which causes distention of the stmach and release of Grehlin from Gastric cells;

FIG. 8 is a view similar to FIG. 6 showing empty Gastric cells and Grehlin bound to a binding compound in the bloodstream;

FIG. 9 depicts in a cross-sectional view a stomach before long term appetite suppressant use;

FIG. 10 is a view similar to FIG. 9 depicting a stomach after several months of appetite suppressant use;

FIG. 11 depicts a stomach a stomach in cross-section after 6 months of appetite suppressant use decreased 50-60% in size by virtue of physiologic Gastric Bypass;

FIG. 12 represents a cross-sectional view of stomach mucusa before long term appetite suppressant use where Grehlin fills about 95% of Grehlin Gastric cells;

FIG. 13 is a view similar to FIG. 12 representing stomach mucosa after about three months, where Ghrelin fills about 80% of Ghrelin Gastric cells;

FIG. 14 is a view similar to FIG. 13 representing stomach mucosa after about six months, where Grehlin fills only about 50-60% of Grehlin Gastric cells (physiologic Gastric Bypass) with atrophic Grehlin Gasatric cells;

FIG. 15 represents a side elevational view of a digestive system depicting a surgical Ronx-En-Y Gastric Bypass; and

FIG. 16 represents a side elevational view of a digestive system depicting a Lap-Band Gastric Bypass (endoscopic procedure).

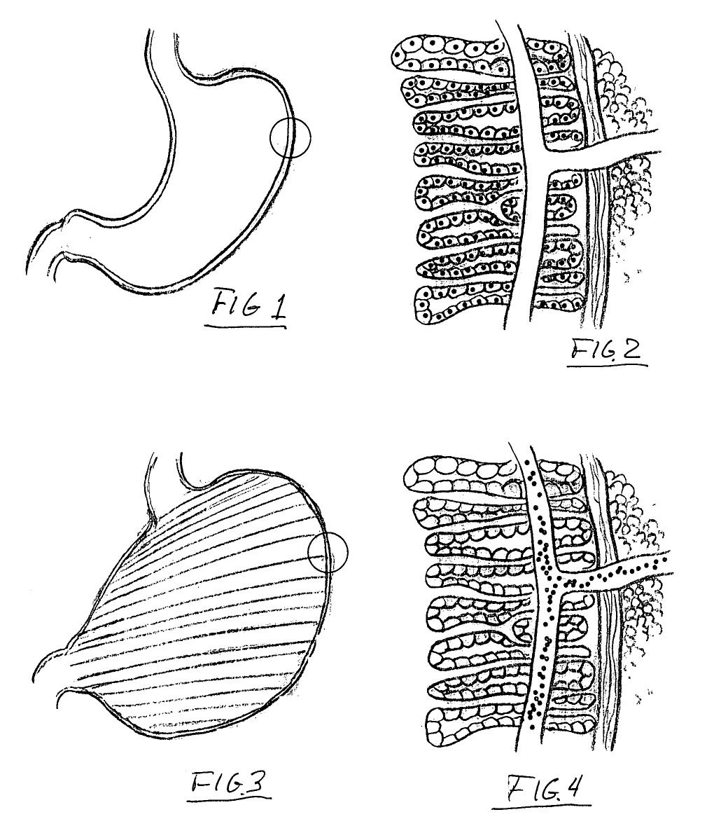

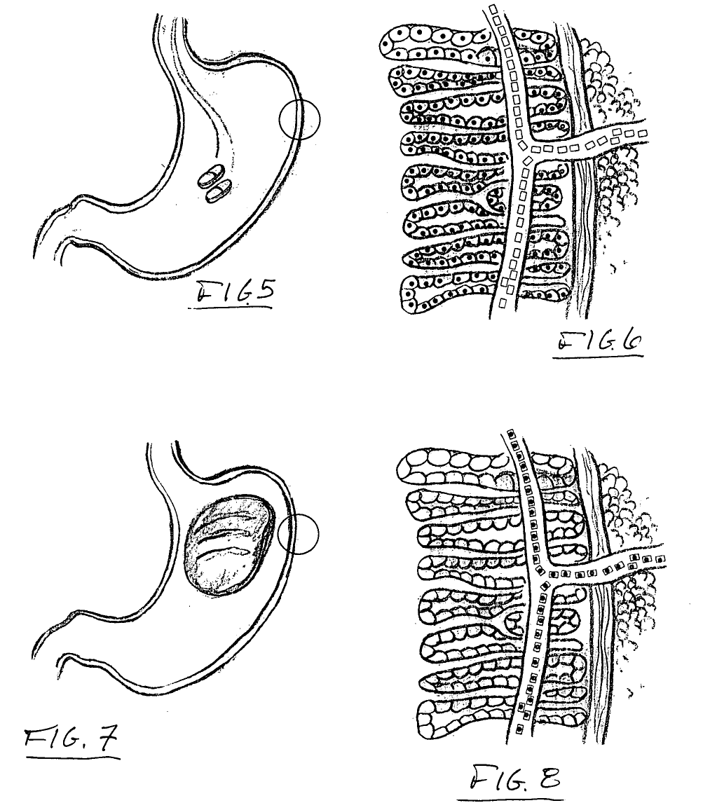

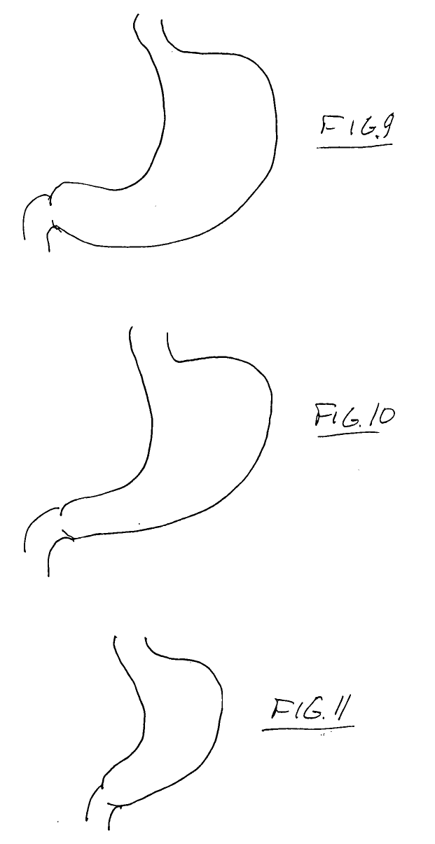

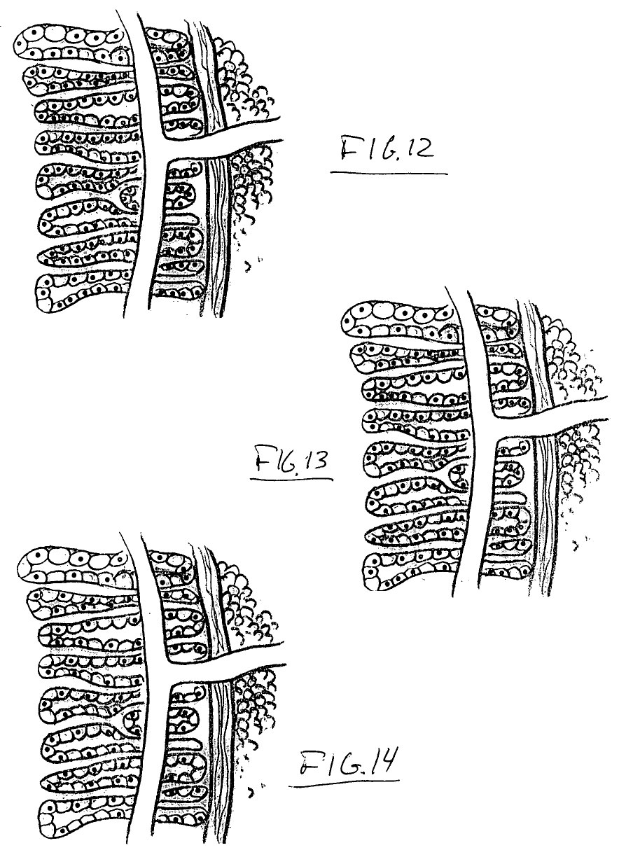

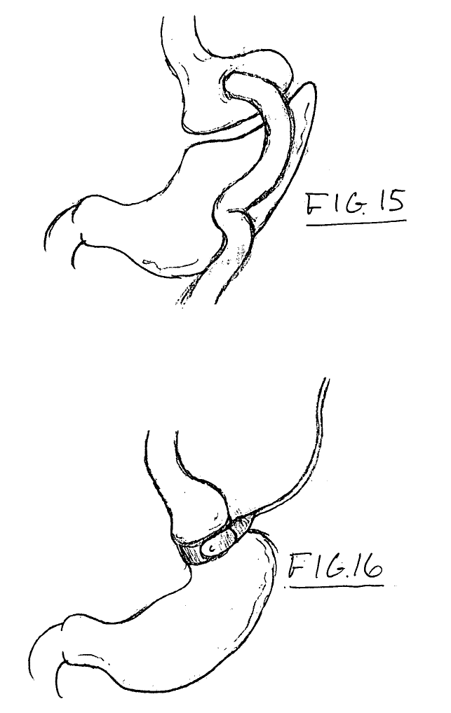

### DETAILED DESCRIPTION OF PRESENT INVENTION

The present invention is actually three individual components.

1) A compound to be taken orally two hours before meals to block the free ghrelin in the circulating blood stream. A host of compounds have been subjectively reported as appetite suppressants, but an actual objective reduction in ghrelin level will define the exact composition.

2) A ghrelin release stimulating eatable “cookie” or “bar” that would be consumed one hour before each meal. The mastication and salivary gland output would stimulate ghrelin release. The gastrocholic reflex of eating would stimulate ghrelin release. The “cookie” would be composed of a non-nutritional gastric filling agent such as cellulose or bran fiber to stimulate a ghrelin release by stomach distention. The cookie could also stimulate ghrelin release by the addition of an FDA approved sugar substitute such as saccarin, aspartame, acesalfame-K, or sucralose withhout adding glucose.

The net effect of the above described treatment is to pre-treat with a ghrelin inactivating agent and then stimulate the release of ghrelin, both preprandially. This preprandial appetite suppression is intended to reduce mealtime food intake.

3) The most important aspect of this inocution is to gradually reduce the production and release of ghrelin from the gastric cells on a long-term basis, a physiological gastric bypass. This is to reduce the baseline levels of ghrelin to 70%, 50%, or even 30% of control to reduce long-term appetite. This is slowly and gradually accomplished to allow both maintenance of weight lost by dieting, and to reduce the appetite on a long-term basis. This above described reduction in long-term appetite would be objectively measured by plasma ghrelin levels.

The physiological gastric bypass gradually reduces the plasma ghrelin levels by reducing the total number of cells that are functionally producing ghrelin. The Ghrelin component of the present is a recently discovered hormone neuropeptide that is produced in the stomach, released into the blood, and targets the brain where appetite and satiety are regulated. Ghrelin when injected causes increased food intake in rodents and humans. Long-term ghrelin levels are increased after diet associated weight loss and are probably responsible for the 90% incidence of weight regain. Long-term ghrelin levels are decreased 70% after gastric bypass surgery. The method here described is a two-phase mechanism to first, stimulate the release of ghrelin from the stomach to deplete the ghrelin stored in the gastric cells, and secondly to administer a nutritional supplement that blocks ghrelin's action either in the blood or in the brain. These objectively measured actions, by assay of the plasma ghrelin, suppresses the appetite, especially preprandially. By preprandially suppressing the appetite, the food intake will gradually decrease over time, effectively reducing the gastric volume. The reduced gastric volume will reduce serum ghrelin levels, and therefore the stimulus to increase food intake, having the long-term effect of a physiological gastric bypass with reduced baseline serum ghrelin levels.

I claim:

1. A method to suppress appetite in a mammalian body comprising the steps of:
stimulating the release of Ghrelin from stomach cells;
depleting Ghrelin stored in Gastric cells of the stomach;
blocking a portion of any Ghrelin activity in the brain of the mammalian.

2. The method as recited in claim 1, including;
blocking a portion of any Ghrelin activity in the bloodstream of the mammalian.

3. A method to suppress the Gastric volume of a mammalian stomach comprising the steps of:
reduce serum Ghrelin levels in the Gastric cells of said mammalian stomach.

4. The method as recited in claim 3, wherein said appetite suppression occurrs preprandially.
